(19) United States
(12) Patent Application Publication
(10) Pub. No.: US 2017/0318758 A1
(43) Pub. Date: Nov. 9, 2017

(54) Ultraviolet Radiation Blocking Sheet

(71) Applicant: Kevin Beauregard, Spokane, WA (US)

(72) Inventor: Kevin Beauregard, Spokane, WA (US)

(21) Appl. No.: 15/149,654

(22) Filed: May 9, 2016

(51) Int. Cl. A01G 13/02; A01G 13/08; G02B 5/20

(52) U.S. Cl. CPC A01G 13/0237; G02B 5/208; A01G 13/0281; A01G 13/08

(57) ABSTRACT

An ultraviolet radiation blocking sheet for blocking ultraviolet radiation while allowing passage of visible light includes a film that is substantially transparent to light that has a wavelength of 495 to 570 nanometers. The film also is substantially absorbent of light that has a wavelength shorter than 495 nanometers. The film is configured to position between a light source and an object to be protected from ultraviolet radiation. The film absorbs the ultraviolet radiation emitted from the light source while allowing light that has a wavelength of 495 to 570 nanometers to pass through the film to illuminate the object.

### BACKGROUND OF THE DISCLOSURE

### Field of the Disclosure

The disclosure relates to ultraviolet radiation blocking devices and more particularly pertains to a new ultraviolet radiation blocking sheet for blocking ultraviolet radiation while allowing passage of visible light.

### SUMMARY OF THE DISCLOSURE

An embodiment of the disclosure meets the needs presented above by generally comprising a film that is substantially transparent to light that has a wavelength of 495 to 570 nanometers. The film also is substantially absorbent of light that has a wavelength shorter than 495 nanometers. The film is configured to position between a light source and an object to be protected from ultraviolet radiation. The film absorbs the ultraviolet radiation emitted from the light source while allowing light that has a wavelength of 495 to 570 nanometers to pass through the film to illuminate the object.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of an ultraviolet radiation blocking sheet according to an embodiment of the disclosure.

FIG. 2 is an isometric perspective view of an embodiment of the disclosure.

FIG. 3 is an isometric perspective view of an embodiment of the disclosure.

FIG. 4 is an isometric perspective view of an embodiment of the disclosure.

FIG. 5 is an isometric perspective view of an embodiment of the disclosure.

### DESCRIPTION OF THE PREFERRED EMBODIMENT

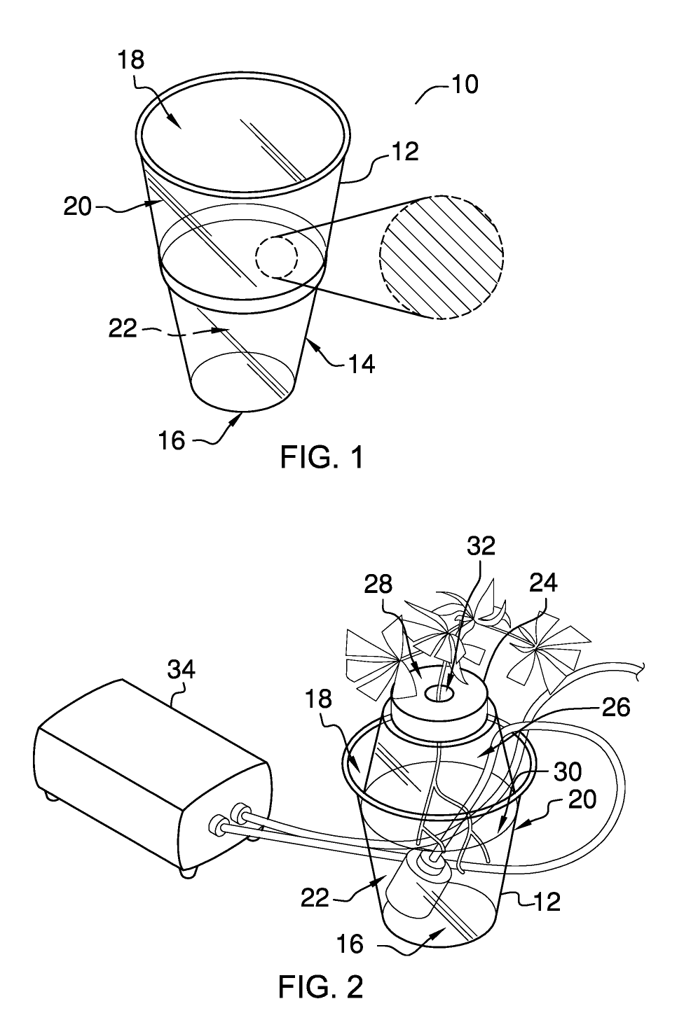

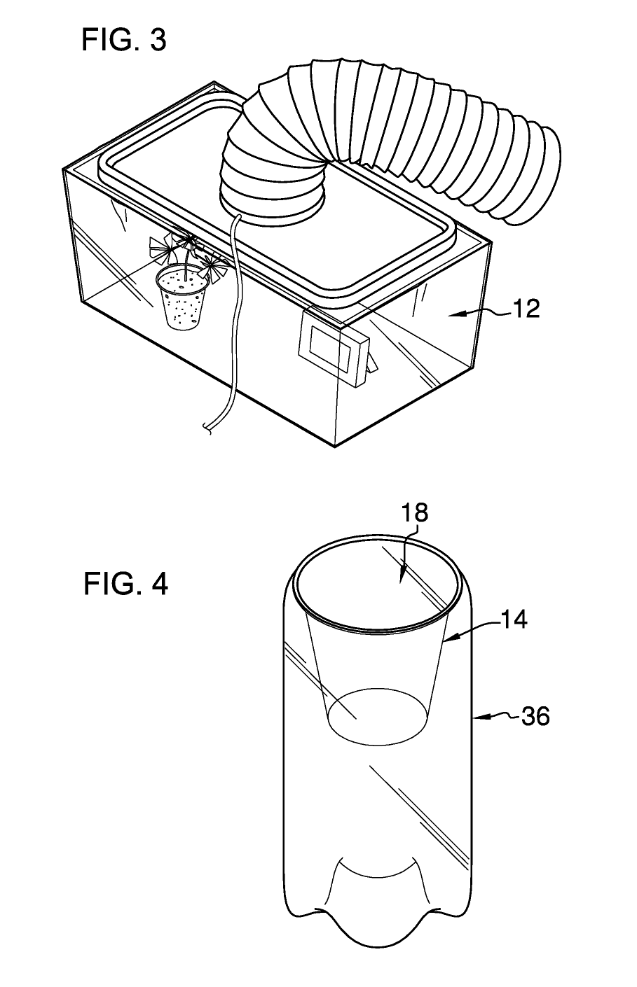

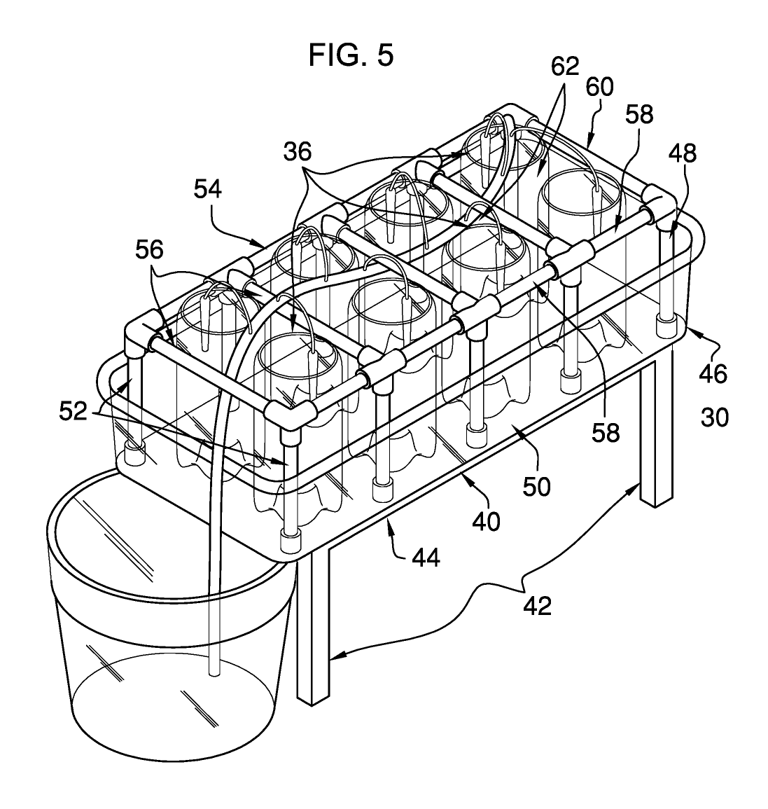

With reference now to the drawings, and in particular to FIGS. 1 through 5 thereof, a new ultraviolet radiation blocking devices embodying the principles and concepts of an embodiment of the disclosure and generally designated by the reference numeral 10 will be described.

As best illustrated in FIGS. 1 through 5, the ultraviolet radiation blocking sheet 10 generally comprises a film 12 that is substantially transparent to light that has a wavelength of 495 to 570 nanometers. The film 12 also is substantially absorbent of light that has a wavelength shorter than 495 nanometers. In one embodiment, the film 12 also is substantially absorbent of light having a wavelength longer than 570 nanometers. In another embodiment, the film 12 is semi-rigid, such that the film 12 is formable into a container 14.

The container 14 has a bottom 16, an open top 18 and an annular wall 20 that define a holding space 22. The container 14 is configured to house the root system of a plant within the holding space 22 while allowing the root system to be inspected through the annular wall 20 and the bottom 16. The bottom 16 is circularly shaped. The open top 18 is dimensionally larger than the bottom 16, such that the container 14 is conical.

The sheet 10 also comprises a cover 24 that is complementary to the container 14. The cover 24 is reversibly couplable to the container 14 to cover the open top 18. In one embodiment, the cover 24 has an annular sidewall 26 extending downwardly from a top face 28 to a bottom face 30. The bottom face 30 is open. The open top 18 of the container 14 is positioned for insertion of the cover 24 such that the annular sidewall 26 of the cover 24 abuts the annular wall 20 of the container 14.

An opening 32 is positioned in the cover 24 and is configured for a leaf portion of the plant to protrude from the container 14. An air pump 34 is fluidically connected to the holding space 22 and is configured to circulate fresh air through the holding space 22.

In one embodiment, the container 14 comprises a plurality of pots 36. Each pot 36 is substantially cylindrically shaped. The plurality of pots 36 comprises eight pots 36.

The present invention comprises a stand 38 that is configured to house the plurality of pots 36. The stand 38 comprises a panel 40 that is rigid and substantially rectangularly shaped. A plurality of legs 42 is coupled to and extends from a lower face 44 of the panel 40. The plurality of legs 42 comprises legs 42 positioned proximate to each corner 46 of the panel 40. A retainer 48 is coupled to and extends from an upper face 50 of the panel 40. The retainer 48 is positioned on the panel 40 such that the retainer 48 is positioned to maintain the pots 36 on the upper face 50 of the panel 40.

The retainer 48 comprises a plurality of verticals 52 that is coupled to and extends perpendicularly from the panel 40. A perimeter rod 54 is coupled to and extends between each of the verticals 52. The perimeter rod 54 is coupled to each vertical 52 distal from the panel 40.

In one embodiment, a plurality of cross supports 56 is coupled to and extends between opposing sides 58 of the perimeter rod 54. The cross supports 56 are substantially evenly space between opposing ends 60 of the perimeter rod 54. The plurality of cross supports 56 comprises three cross supports 56 that define four compartments 62. Each compartment 62 is configured to house two pots 36.

In use, the film 12 is configured to position between a light source and an object to be protected from ultraviolet radiation. The film 12 absorbs the ultraviolet radiation emitted from the light source while allowing light having a wavelength of 495 to 570 nanometers to pass through the film 12 to illuminate the object.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An ultraviolet radiation blocking sheet comprising:
a film, said film being substantially transparent to light having a wavelength of 495 to 570 nanometers, said film being substantially absorbent of light having a wavelength shorter than 495 nanometers; and
wherein said film is configured for positioning between a light source and an object to be protected from ultraviolet radiation, such that said film absorbs the ultraviolet radiation emitted from the light source while allowing light having a wavelength of 495 to 570 nanometers to pass through said film to illuminate the object.

2. The sheet of claim 1 further including said film being substantially absorbent of light having a wavelength longer than 570 nanometers.

3. The sheet of claim 1 further including said film being semi-rigid, such that said film is formable into a container.

4. The sheet of claim 3 further including said container having a bottom, an open top and an annular wall defining a holding space, such that said container is configured to house the root system of a plant within said holding space while allowing the root system to be inspected through said annular wall and said bottom.

5. The sheet of claim 4 further including said bottom being circularly shaped, said open top being dimensionally larger than said bottom, such that said container is conical.

6. The sheet of claim 4 further including a cover complementary to said container, said cover being reversibly couplable to said container to cover said open top.

7. The sheet of claim 6 further including said cover having an annular sidewall extending downwardly from a top face to a bottom face, said bottom face being open, wherein said open top of said container is positioned for insertion of said cover such that said annular sidewall of said cover abuts said annular wall of said container.

8. The sheet of claim 7 further including an opening positioned in said cover, wherein said opening is positioned in said cover such that said opening is configured for a leaf portion of the plant to protrude from said container.

9. The sheet of claim 4 further including an air pump fluidically connected to said holding space, wherein said air pump is configured to circulate fresh air through said holding space.

10. The sheet of claim 4 further including said container comprising a plurality of pots.

11. The sheet of claim 10 further including a stand configured to house said plurality of pots.

12. The sheet of claim 10 further including each said pot being substantially cylindrically shaped.

13. The sheet of claim 12 further including said plurality of pots comprising eight said pots.

14. The sheet of claim 11 further including said stand comprising:
a panel, said panel being rigid, said panel being substantially rectangularly shaped;
a plurality of legs coupled to and extending from a lower face of said panel; and
a retainer coupled to and extending from an upper face of said panel, wherein said retainer is positioned on said panel such that said retainer is positioned to maintain said pots on said upper face of said panel.

15. The sheet of claim 14 further including said plurality of legs comprising said legs positioned proximate to each corner of said panel.

16. The sheet of claim 14 further including said retainer comprising:
a plurality of verticals coupled to and extending perpendicularly from said panel;
a perimeter rod coupled to and extending between each of said verticals, said perimeter rod being coupled to each said vertical distal from said panel;
a plurality of cross supports coupled to and extending between opposing sides of said perimeter rod, said cross supports being substantially evenly space between opposing ends of said perimeter rod.

17. The sheet of claim 16 further including said plurality of cross supports comprising three said cross supports defining four compartments, wherein each said compartment is configured to house two said pots.

18. An ultraviolet radiation blocking sheet comprising:
a film, said film being substantially transparent to light having a wavelength of 495 to 570 nanometers, said film being substantially absorbent of light having a wavelength shorter than 495 nanometers, said film being substantially absorbent of light having a wavelength longer than 570 nanometers, said film being semi-rigid, such that said film is formable into a container;
said container having a bottom, an open top and an annular wall defining a holding space, such that said container is configured to house the root system of a plant within said holding space while allowing the root system to be inspected through said annular wall and said bottom, said bottom being circularly shaped, said open top being dimensionally larger than said bottom, such that said container is conical;
a cover complementary to said container, said cover being reversibly couplable to said container to cover said open top, said cover having an annular sidewall extending downwardly from a top face to a bottom face, said bottom face being open, wherein said open top of said container is positioned for insertion of said cover such that said annular sidewall of said cover abuts said annular wall of said container;
an opening positioned in said cover, wherein said opening is positioned in said cover such that said opening is configured for a leaf portion of the plant to protrude from said container;
an air pump fluidically connected to said holding space, wherein said air pump is configured to circulate fresh air through said holding space;
said container comprising a plurality of pots, each said pot being substantially cylindrically shaped, said plurality of pots comprising eight said pots,
a stand configured to house said plurality of pots, said stand comprising:
a panel, said panel being rigid, said panel being substantially rectangularly shaped,
a plurality of legs coupled to and extending from a lower face of said panel, said plurality of legs comprising said legs positioned proximate to each corner of said panel, and
a retainer coupled to and extending from an upper face of said panel, wherein said retainer is positioned on said panel such that said retainer is positioned to maintain said pots on said upper face of said panel, said retainer comprising:
a plurality of verticals coupled to and extending perpendicularly from said panel,
a perimeter rod coupled to and extending between each of said verticals, said perimeter rod being coupled to each said vertical distal from said panel, and
a plurality of cross supports coupled to and extending between opposing sides of said perimeter rod, said cross supports being substantially evenly space between opposing ends of said perimeter rod, said plurality of cross supports comprising three said cross supports defining four compartments, wherein each said compartment is configured to house two said pots; and
wherein said film is configured for positioning between a light source and an object to be protected from ultraviolet radiation, such that said film absorbs the ultraviolet radiation emitted from the light source while allowing light having a wavelength of 495 to 570 nanometers to pass through said film to illuminate the object.
